(19) United States
(12) Patent Application Publication
(10) Pub. No.: US 2009/0114055 A1
(43) Pub. Date: May 7, 2009

(54) Steering column locking mechanism

(75) Inventor: Patrick R. Stroud, Lafayette, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/982,759

(22) Filed: Nov. 5, 2007

(51) Int. Cl. B62D 1/184

(52) U.S. Cl. 74/493

(57) ABSTRACT

A steering column (10) includes a support (24) through which a steering column member (12) extends connected with a mounting bracket (68). A locking mechanism (130) locks the support (24) in any one of a plurality of positions relative to the mounting bracket (68). The locking mechanism (130) has first and second cams (148, 132). The first cam (148) is rotatable relative to the second cam (132) and has a first cam surface (150). The locking mechanism (130) clamps the support (24) to the mounting bracket (68) when the first cam (148) is in a first position relative to the second cam (132). The support (24) is movable relative to the mounting bracket (68) and the locking shaft (200) is prevented from moving relative to the mounting bracket when the first cam (148) is in a second position relative to the second cam (132). A torsion spring (300) urges the first cam (148) toward the first position.

### FIELD OF THE INVENTION

The present invention relates to an adjustable steering column, and more specifically, to a locking mechanism for an adjustable steering column.

### BACKGROUND OF THE INVENTION

A known steering column is disclosed in U.S. Pat. No. 6,952,979. U.S. Pat. No. 6,952,979 discloses an adjustable steering column. The steering column includes a support through which a steering column member extends connected with a mounting bracket. A locking mechanism locks the support in any one of a plurality of positions relative to the mounting bracket. The locking mechanism has first and second cams. The first cam is rotatable relative to the second cam.

The locking mechanism clamps the support to the mounting bracket when the first cam is in a first position relative to the second cam. The support is movable relative to the mounting bracket when the first cam is in a second position relative to the second cam.

After the support is moved to a desired position, the first cam is rotated relative to the second cam from the second position to the first position to prevent the support from moving from the desired position. An external gas spring can be connected to the first cam to urge the first cam to rotate relative to second cam from the second position to the first position. However, the gas spring requires additional space and costs.

### SUMMARY OF THE INVENTION

A steering column of the present invention includes a steering column member connectable with a steering wheel and rotatable to turn steerable vehicle wheels. A mounting bracket connects the steering column to a vehicle frame. A support through which the steering column member extends is connected with the mounting bracket. The support supports the steering column member for rotation about a longitudinal axis of the steering column member and is movable relative to the mounting bracket.

A locking mechanism locks the support in any one of a plurality of positions relative to the mounting bracket. The locking mechanism has first and second cams. The first cam is rotatable relative to the second cam and has a first cam surface. The second cam has a second cam surface facing the first cam surface. The locking mechanism clamps the support to the mounting bracket when the first cam is in a first position relative to the second cam. The support is movable relative to the mounting bracket when the first cam is in a second position relative to the second cam. A torsion spring urges the first cam towards the first position.

In another aspect, a steering column of the present invention includes a steering column member connectable with a steering wheel and rotatable to turn steerable vehicle wheels. A mounting bracket connects the steering column to a vehicle frame. A support through which the steering column member extends is connected with the mounting bracket. The support supports the steering column member for rotation about a longitudinal axis of the steering column member and is movable relative to the mounting bracket.

A locking mechanism locks the support in any one of a plurality of positions relative to the mounting bracket. The locking mechanism has a locking shaft extending through first and second cams and the mounting bracket. The first cam is rotatable relative to the locking shaft and the second cam and has a first cam surface. The second cam has a second cam surface facing the first cam surface. The locking mechanism clamps the support to the mounting bracket when the first cam is in a first position relative to the second cam. The support is movable relative to the mounting bracket and the locking shaft is prevented from moving relative to the mounting bracket when the first cam is in a second position relative to the second cam. A torsion spring urges the first cam toward the first position.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic pictorial view of a steering column constructed in accordance with the present invention;

FIG. 2 is an exploded view of the steering column of FIG. 1;

FIG. 3 is an enlarged exploded view of a portion of a locking mechanism of the steering column of FIG. 1;

FIG. 4 is a right side view with respect to FIG. 1 of the cam members and related elements of the steering column connected together; and

FIG. 5 is an enlarged exploded view of a portion of the locking mechanism of the steering column as viewed from the left side with respect to FIG. 3.

### DESCRIPTION OF THE INVENTION

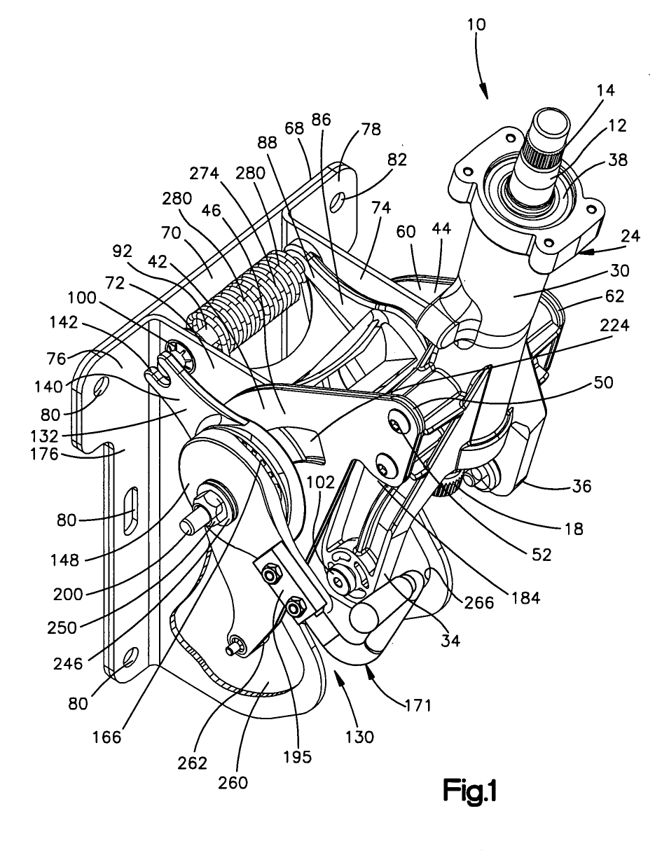

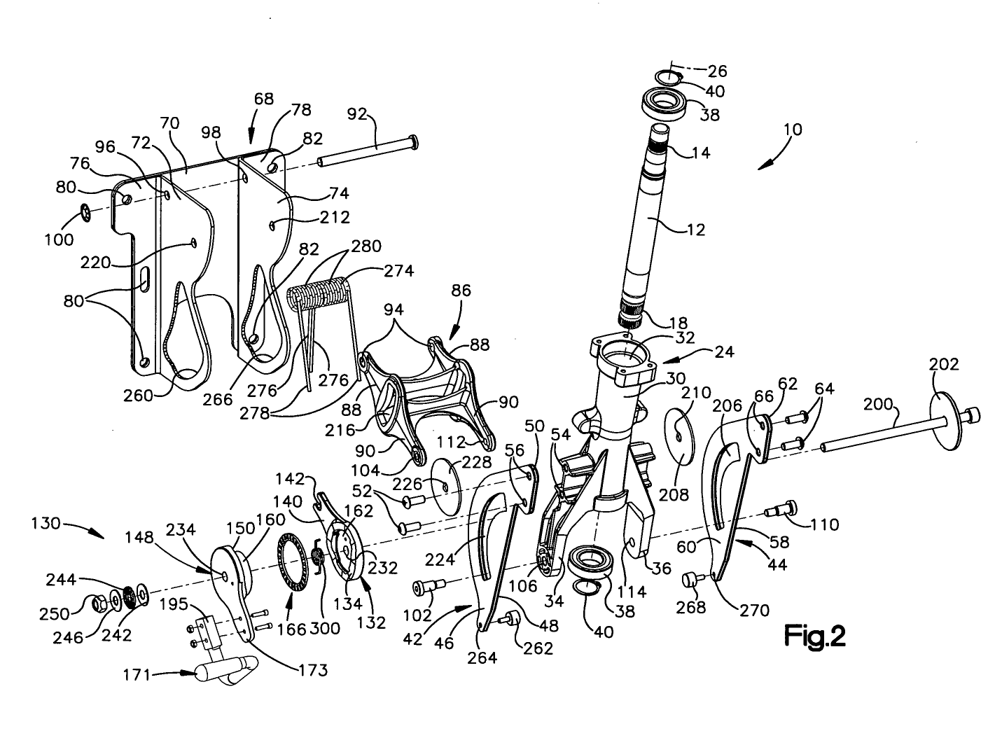

A vehicle steering column 10 is illustrated in FIGS. 1 and 2. The steering column 10 includes a rotatable steering column member 12 to turn steerable vehicle wheels (not shown). The steering column member 12 has an end 14 connectable with a steering wheel (not shown) in any suitable manner. An end 18 of the steering column member 12 opposite from the end 14 is connectable with a universal joint (not shown). The universal joint connected with the end 18 of the steering column member 12 is connectable with a mechanism designed to transmit movement of the steering column member to a steering gear and permit movement of the steering column member relative to the mechanism, as known in the art.

A support 24 (FIGS. 1 and 2) supports the steering column member 12 for rotation about a longitudinal axis 26 of the steering column member. Upon rotation of the steering wheel, the steering column member 12 rotates about the longitudinal axis 26. Upon rotation of the steering column member 12 about the longitudinal axis 26, steerable vehicle wheels (not shown) are turned, as known in the art.

The support 24 (FIG. 2) has a tubular portion 30 with a passage 32 through which the steering column member 12 extends. Arm portions 34 and 36 extend from the tubular portion 30. The tubular portion 30 is made by casting and may have any desired shape. Bearings 38 axially located in the passage 32 support the steering column member 12 for rotation relative to the support 24. The bearings 38 are retained in the tubular portion 30 by snap rings 40.

The support 24 includes locking portions 42 and 44 extending axially from opposite sides of the tubular portion 30. The locking portion 42 includes plates 46 and 48 fixedly connected to each other with a spacer 50 between them. The locking portion 42 is fixedly connected to the tubular portion 30 by fasteners 52, such as screws. The fasteners 52 threadably engage openings 54 in the tubular portion 30 and extend through openings 56 in the plates 46 and 48 and through openings in the spacer 50.

The locking portion 44 is identical to locking portion 42 and therefore, will not be described in detail. The locking portion 44 includes plates 58 and 60 fixedly connected to each other with a spacer 62 between them. The locking portion 44 is fixedly connected to the tubular portion 30 by fasteners 64, such as screws. The fasteners 64 threadably engage openings in the tubular portion 30 and extend through openings 66 in the plates 58 and 60 and through openings in the spacer 62.

A mounting bracket 68 (FIGS. 1 and 2) connects the steering column 10 with a vehicle frame. The mounting bracket 68 includes a rear wall 70. Side walls 72 and 74 are connected to the rear wall 70. The side wall 72 includes a flange 76 extending parallel to and engaging the rear wall 70. The side wall 74 includes a flange 78 extending parallel to and engaging the rear wall 70. The side walls 72 and 74 extend generally perpendicular to the rear wall 70 and parallel to each other. The mounting bracket 68 is connected to the vehicle frame by fasteners (not shown), such as bolts, extending through openings 80 in the flange 76 of the side wall 72 and through openings in the rear wall 70. The mounting bracket 66 is also connected to the vehicle frame using fasteners (not shown), such as bolts, extending through openings 82 in the flange 78 of the side wall 74 and through openings in the rear wall 70.

A pivot member 86 (FIG. 2) interconnects the support 24 and the mounting bracket 68. The member 86 is generally H-shaped, as seen in FIG. 2. The pivot member 86 has a pair of arms 88 extending from one side of the pivot member toward the rear wall 70. The arms 88 are pivotally connected to the side walls 72 and 74. A pair of arms 90 extending from an opposite side of the pivot member 86 away from the rear wall 70 are pivotally connected with the support 24.

A pivot shaft 92 extends through openings 94 in the arms 88 of the pivot member 86. The shaft 92 is received in an opening 96 in the side wall 72 and extends through an opening 98 in the side wall 74 to pivotally connect the pivot member 86 to the mounting bracket 68. A retaining member 100 holds the pivot shaft 92 in the side walls 72 and 74. Accordingly, the pivot member 86 can pivot relative to the mounting bracket 68.

A pin 102 (FIG. 2) pivotally connects one of the arms 90 of the pivot member 86 to the support 24. The pin 102 extends through an opening 104 in the arm 90 and into an opening 106 in the arm portion 34 of the support 24. A pin 110 pivotally connects the other arm 90 of the pivot member 86 with the arm portion 36 of the support 24. The pin 110 extends through an opening 112 in the other arm 90 and into an opening 114 in the arm portion 36 of the support 24. Accordingly, the support 24 can pivot relative to the pivot member 86.

A locking mechanism 130 (FIGS. 1 and 2) locks the pivot member 86 in any one of a plurality of pivot positions relative to the mounting bracket 68. The locking mechanism 130 also locks the support 24 in any one of a plurality of pivot positions relative to the pivot member 86. The locking mechanism 130 applies a force to clamp the side wall 72 between the pivot member 86 and the locking portion 42 of the support 24. The locking mechanism 130 also clamps the side wall 74 between the pivot member 86 and the locking portion 44 of the support 24.

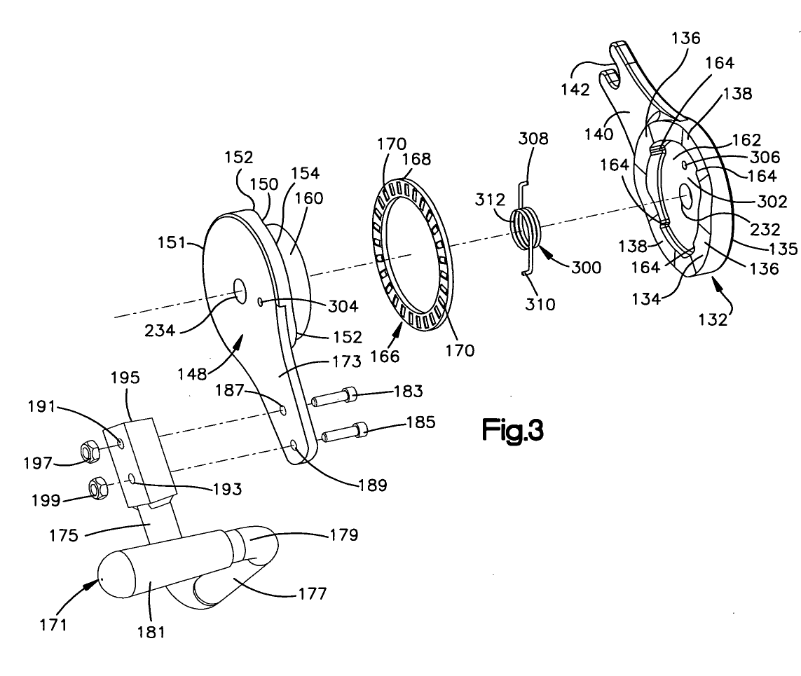

The locking mechanism 130 includes a cam 132 engaging the locking portion 42 of the support 24. The cam 132 (FIGS. 2 and 3) has a cam surface 134 facing away from the locking portion 42 and a surface 135 facing towards the locking portion 42. The cam surface 134 (FIG. 3) has high portions 136 and low portions 138. The high portions 136 extend away from the locking portion 42 a greater distance than the low portions 138. The cam 132 also includes a radially extending arm 140 with a recess 142. The pivot shaft 92 (FIGS. 1 and 2) extends into the recess 142 in the cam 132 to prevent rotation of the cam 132 relative to the mounting bracket 68.

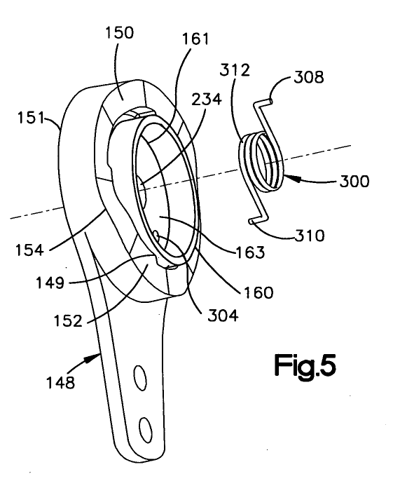

The locking mechanism 130 (FIG. 3) includes a cam 148 rotatable relative to the cam 132. As depicted in FIGS. 3 and 5, the cam 148 has a cam surface 150 facing the cam surface 134 on the cam 132 and a surface 151 opposite the cam surface 150. The cam surface 150 has high portions 152 and low portions 154. The high portions 152 extend toward the cam 132 a greater distance than the low portions 154.

A cylindrical boss 160 extends from the cam 148 toward the cam 132. The boss 160 extends into a recess 162 in the cam 132. As seen in FIG. 5, a recess 161 is formed in the boss 160. An aperture 304 is formed in a wall 163 of the cam 148. The wall 163 partially defines the recess 161.

The cam 132 has a plurality of stop surfaces 164 defining the recess 162. Although four stop surfaces 164 are shown in FIG. 3, it is contemplated that the cam 132 could have any number of stop surfaces. The cam 148 has portions 149 that engage the stop surfaces 164 to define limits of relative rotation between the cams 132 and 148. An aperture 306 is formed in a wall 302 the cam 132. The wall 302 partially defines the recess 162.

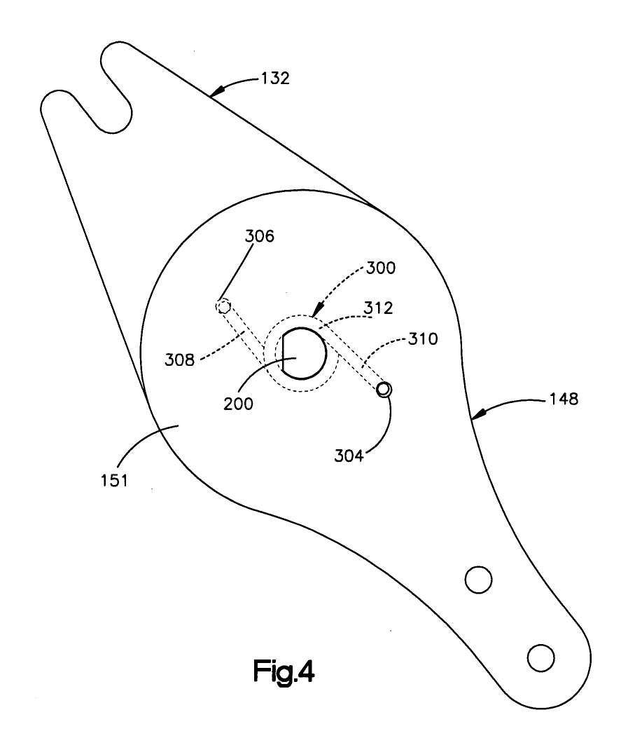

Referring to FIGS. 3 and 4, a torsion spring 300 is positioned within the recesses 161, 162 of the respective cams 148, 132. The spring 300 urges the cam 148 to rotate relative to the cam 132. The spring 300 abuts against the wall 302 of the cam 132 and the wall 163 of the cam 148. The torsion spring 300 includes a coiled portion 312 with a longitudinal axis that is coaxial with the axis of rotation of the cam 148. The torsion spring 300 includes a first end 308 and a second end 310. The first end 308 extends into the aperture 306 of the cam 132 to affix the torsion spring 300 to the cam 132. The second end 310 extends into the aperture 304 of the cam 148 to affix the torsion spring 300 to the cam 148.

The boss 160 extending from the cam 148 supports a bearing 166 for rotation relative to the cams 132 and 148. The bearing 166 includes a flexible cage 168 and a plurality of bearing members 170 rotatable relative to the cage. The bearing members 170 engage the cam surfaces 134 and 150 on the cams 132 and 148. It is contemplated that the bearing members 170 could be needle bearings or ball thrust bearings.

Referring to FIGS. 2 and 3, the cam 148 includes a radially extending arm 173. A handle 171 is connected to the arm for manually applying a force to rotate the cam 148 relative to the cam 132. The handle 171 includes a radially extending inner portion 175, a middle portion 177, and an outer portion 179. These portions 175, 177, 179 may be formed as one piece. The middle portion 177 of the handle 171 extends generally perpendicular to the inner portion 175. The outer portion 179 extends generally perpendicular to the middle portion 177. A grip 181 covers a portion of the outer portion 179.

The handle 171 is connected to the arm 173 by a screws 183, 185. The screws 183, 185 extend through apertures 187, 189 in the arm 173, apertures (not shown) in the inner portion 175, and apertures 191, 193 in a mounting bracket 195. The inner portion 175 extends partially into the mounting bracket 195 for connecting the handle 171 the arm 173. Nuts 197, 199 are threaded on the ends of the screws 183, 185 to secure the handle 171 to the arm 173.

A locking shaft 200 (FIG. 2) having a D-shaped cross section extends through a washer 202 engaging the locking portion 44. The locking shaft 200 also extends through a C-shaped slot 206 in the locking portion 44 and a washer 208 between the plates 58 and 60 of the locking portion 44. The washer 208 has a D-shaped opening 210 through which the locking shaft 200 extends to prevent rotation of the washer 208 relative to the locking shaft. The locking shaft 200 also extends through a D-shaped opening 212 in the side wall 74 of the mounting bracket 68 to prevent movement of the locking shaft relative to the mounting bracket. The pivot member 86 has a slot 216 through which the locking shaft 200 extends to permit movement of the pivot member relative to the locking shaft. The locking shaft 200 extends through a D-shaped opening 220 in the side wall 72 to further prevent movement of the locking shaft relative to the mounting bracket 68. The locking shaft 200 also extends through a C-shaped slot 224 in the locking portion 42 of the support 24 and a D-shaped opening 226 in a washer 228 extending between the plates 46 and 48 of the locking portion 42.

The locking shaft 200 extends through an opening 232 in the cam 132, the bearing 166, and an opening 234 in the cam 148 so that the cam 148 is rotatable relative to the locking shaft 200. The locking shaft 200 extends through the coiled portion 312 of the torsion spring 300. The torsion spring 300 is rotatable relative to the locking shaft 200. The locking shaft 200 also extends through a washer 242 engaging the cam 148, a thrust bearing 244 engaging the washer 242, and a washer 246 engaging the thrust bearing 244. A nut 250 is threaded onto the locking shaft 200 and engages the washer 246.

The handle 171 is manually engageable to rotate the cam 148 about the locking shaft 200 relative to the cam 132. When the cam 148 is in a first position relative to the cam 132, the high portions 152 on the cam 148 are aligned with the high portions 136 on the cam 132 and the locking mechanism 130 clamps the support 24 to the mounting bracket 68. When the cam 148 is rotated by the handle 171 relative to the cam 132 to a second position in which the low portions 154 on the cam 148 are aligned with the high portions 136 on the cam 132, the support 24 is movable relative to the mounting bracket 68. When the support 24 moves relative to the mounting bracket 68, the locking shaft 200 is prevented from moving relative to the mounting bracket by the openings 220 and 212 in the mounting bracket. The torsion spring 300 exerts a biasing force to urge the cam 148 toward the first position relative to the cam 132. Thus, the force that is manually applied to the handle 171 to rotate the cam 148 relative to the cam 132 from the first position to the second position must be greater than the biasing force of the torsion spring 300.

The side wall 72 (FIG. 2) of the mounting bracket 68 has a pear-shaped opening 260 into which a pin 262 connected with the support 24 extends. The pin 262 extends through openings 264 in the locking portion 42 of the support 24. The side wall 74 has a pear-shaped opening 266 into which a pin 268 connected with the support 24 extends. The pin 268 extends through openings 270 in the locking portion 44 of the support 24. The pins 262 and 268 engage surfaces defining the openings 260 and 266 to define the limits of movement of the support 24 relative to the mounting bracket 68. The openings 260 and 266 have a generally pear-shaped configuration, however, the openings 260 and 266 may have any desired shape.

A spring member 274 urges the support 24 toward an out of the way position relative to the mounting bracket 68. The spring member 274 has end portions 276 that engage the rear wall 70 of the mounting bracket 68. The spring member 274 has opposite end portions 278 that engage the arm portions 34 and 36 of the support 24 to urge the support member 24 toward the out of the way position. The pivot shaft 92 extends through coil portions 280 of the spring member 274 to connect the spring member to the mounting bracket 68.

The support 24 is prevented from moving relative to the mounting bracket 68 when the cam 148 is in the first position relative to the cam 132. The support 24 can be moved relative to the mounting bracket 68 when the cam 148 is rotated about the locking shaft 200 relative to the cam 132 from the first position to the second position. After the support 24 is moved to a desired position and the handle 171 is released, the torsion spring 300 rotates the cam 148 relative to the cam 132 from the second position to the first position to prevent the support from moving from the desired position.

Although a manually engageable handle 171 for rotating the cam 148 relative to the cam 132 is shown, it is contemplated that any mechanism may be used to rotate the cam 148 relative to the cam 132.

From the above description of the invention, those skilled in the art will perceive improvements, changes and modifications. Such improvements, changes and modifications within the skill of the art are intended to be covered by the appended claims.

Having described the invention, the following is claimed:

1. A steering column comprising:
a steering column member connectable with a steering wheel and rotatable to turn steerable vehicle wheels;
a mounting bracket which connects said steering column to a vehicle frame;
a support connected with said mounting bracket and through which said steering column member extends, said support supporting said steering column member for rotation about a longitudinal axis of said steering column member and being movable relative to said mounting bracket;
a locking mechanism which locks said support in any one of a plurality of positions relative to said mounting bracket, said locking mechanism having first and second cams, said first cam being movable relative to said second cam, said locking mechanism clamping said support to said mounting bracket when said first cam is in a first position relative to said second cam, said support being movable relative to said mounting bracket when said first cam is in a second position relative to said second cam; and
a torsion spring urging said first cam toward said first position.

2. A steering column as defined in claim 1 wherein one of said first and second cams has a recess, said torsion spring being positioned in said recess.

3. A steering column as defined in claim 1 wherein a locking shaft extends through said torsion spring.

4. A steering column as defined in claim 1 wherein said torsion spring includes a first end connected to said first cam, said torsion spring further includes a second end connected to said second cam.

5. A steering column as defined in claim 4 wherein said first end extends into an aperture in said first cam, said second end extends into an aperture in said second cam.

6. A steering column comprising:
a steering column member connectable with a steering wheel and rotatable to turn steerable vehicle wheels;
a mounting bracket which connects said steering column to a vehicle frame;
a support connected with said mounting bracket and through which said steering column member extends, said support supporting said steering column member for rotation about a longitudinal axis of said steering column member and being movable relative to said mounting bracket;
a locking mechanism which locks said support in any one of a plurality of positions relative to said mounting bracket, said locking mechanism having a locking shaft extending through first and second cams and said mounting bracket, said first cam being rotatable relative to said locking shaft and said second cam and having a first cam surface, said second cam having a second cam surface facing said first cam surface, said locking mechanism clamping said support to said mounting bracket when said first cam is in a first position relative to said second cam, said support being movable relative to said mounting bracket and said locking shaft being prevented from moving relative to said mounting bracket when said first cam is in a second position relative to said second cam; and
a torsion spring urging said first cam toward said first position.

7. A steering column as defined in claim 6 wherein one of said first and second cams has a recess, said torsion spring being positioned in said recess.

8. A steering column as defined in claim 6 wherein said locking shaft extends through said torsion spring.

9. A steering column as defined in claim 6 wherein said torsion spring includes a first end connected to said first cam, said torsion spring further includes a second end connected to said second cam.

10. A steering column as defined in claim 9 wherein said first end extends into an aperture in said first cam, said second end extends into an aperture in said second cam.

11. A steering column as defined in claim 6 including a bearing located between said first and second cams and engaging said first and second cam surfaces, said bearing being rotatable relative to said first and second cams.

12. A steering column as defined in claim 11 wherein said bearing includes a flexible cage and a plurality of bearing members rotatable relative to said cage, said bearing members engaging said first and second cam surfaces.

13. A steering column as defined in claim 6 further including an actuator connected with said first cam, said actuator rotating said first cam relative to said second cam upon application of a force to said actuator to rotate said actuator.

14. A steering column as defined in claim 6 further including a member pivotally connected to said mounting bracket, said support being pivotally connected to said member, said locking mechanism preventing pivotal movement of said member relative to said mounting bracket and pivotal movement of said support relative to said member when said first cam is in said first position relative to said second cam.

15. A steering column as defined in claim 14 wherein said locking shaft extends through said member and said support.

16. A steering column as defined in claim 6 wherein said first cam is engageable with said second cam to limit rotation of said first cam relative to said second cam.
